(19) United States
(12) Patent Application Publication
(10) Pub. No.: US 2015/0307707 A1
(43) Pub. Date: Oct. 29, 2015

(54) FLAME-RETARDANT POLYCARBONATE MOLDING MATERIALS VI

(71) Applicant: BAYER MATERIALSCIENCE AG, Leverkusen (DE)

(72) Inventors: Mathieu JUNG, Shanghai (CN); Thomas ECKEL, Dormagen (DE); Vera TASCHNER, Langenfeld (DE)

(21) Appl. No.: 14/649,610

(22) PCT Filed: Dec. 3, 2013
(86) PCT No.: PCT/EP2013/075432

§ 371 Date: Jun. 4, 2015

(30) Foreign Application Priority Data
Dec. 7, 2012 (EP) 12196048.8

(51) Int. Cl. C08L 69/00; C07F 9/659

(52) U.S. Cl. CPC C08L 69/005; C08L 69/00; C07F 9/659; C08L 2205/03

(57) ABSTRACT

The present invention relates to flame-retardant, impact-modified polycarbonate (PC) compositions and moulding compositions having a property combination of excellent mechanical properties, very good flame resistance, high hydrolytic stability and high resistance to chemicals (ESC behaviour).

The present application additionally relates to the use of the compositions in the production of moulded articles, and to moulded articles produced from the compositions.

The present invention relates to flame-retardant, impact-modified polycarbonate (PC) compositions comprising cyclic phosphazenes, which compositions have excellent mechanical properties, very good flame resistance, high resistance to chemicals and high hydrolytic stability, and also to processes for their production, and to the use of cyclic phosphazenes as flame retardants in polycarbonate compositions.

EP 1 095 099 A1 describes polycarbonate/ABS moulding compositions provided with phosphazenes and phosphorus compounds, which compositions have excellent flame retardancy and very good mechanical properties such as joint line strength or notched impact strength.

EP 1 196 498 A1 describes moulding compositions provided with phosphazenes and based on polycarbonate and graft polymers selected from the group of the silicone, EP(D)M and acrylate rubbers as graft base, which compositions have excellent flame retardancy and very good mechanical properties such as stress cracking resistance or notched impact strength.

EP 1 095 100 A1 describes polycarbonate/ABS moulding compositions comprising phosphazenes and inorganic nanoparticles, which compositions have excellent flame retardancy and very good mechanical properties.

EP 1 095 097 A1 describes polycarbonate/ABS moulding compositions provided with phosphazenes, which compositions have excellent flame retardancy and very good processing properties, wherein the graft polymer is produced by means of mass, solution or mass-suspension polymerisation processes.

JP 2000 351893 discloses impact-modified polycarbonate moulding compositions comprising phosphazenes, which compositions are distinguished by good hydrolytic stability, good flame retardancy and stability of the electrical properties.

In the above-mentioned documents, linear and cyclic phosphazenes are disclosed. In the case of the cyclic phosphazenes, the contents of trimers, tetramers and higher oligomers are not specified, however.

JP 1995 0038462 describes polycarbonate compositions comprising graft polymers, phosphazenes as flame retardants and optionally vinyl copolymers. Specific structures, compositions and amounts of the flame retardant are not mentioned, however.

JP19990176718 describes thermoplastic compositions consisting of aromatic polycarbonate, copolymer of aromatic vinyl monomers and vinyl cyanides, graft polymer of alkyl (meth)acrylates and rubber, and phosphazene as flame retardant, which compositions have good flowability.

Accordingly, the object of the present invention is to provide a flame-retardant moulding composition which is distinguished by a property combination of high hydrolytic stability, high resistance to chemicals (ESC behaviour) and a high modulus of elasticity while having consistently good mechanical properties.

It is a further object of the invention to provide flame-retardant moulding compositions which, while having good flame retardancy, have only a low phosphazene content, because flame retardants represent a considerable cost factor in the production of these compositions, so that they become less expensive.

The moulding compositions are preferably flame retardant and fulfill the requirements of UL94 with V-0 even at thin wall thicknesses (i.e. wall thickness of 1.5 mm).

It has been found, surprisingly, that the object of the present invention is achieved by compositions comprising
A) from 60 to 95 parts by weight, preferably from 65 to 90 parts by weight, more preferably from 70 to 85 parts by weight, particularly preferably from 76 to 88 parts by weight, of aromatic polycarbonate and/or aromatic polyester carbonate,
B) from 1.0 to 15.0 parts by weight, preferably from 3.0 to 12.5 parts by weight, particularly preferably from 4.0 to 10.0 parts by weight, of rubber-modified graft polymer selected from the group consisting of silicone rubber, silicone-acrylate rubber and acrylate rubber, preferably silicone-acrylate rubber as graft base,
C) from 1.0 to 20.0 parts by weight, preferably from 1.0 to 15.0 parts by weight, more preferably from 1.0 to 12.5 parts by weight, particularly preferably from 1.5 to 10.0 parts by weight, of at least one cyclic phosphazene of structure (X)

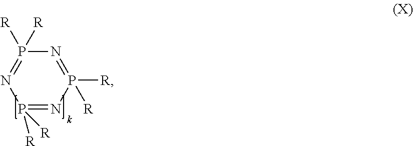

wherein
k represents 1 or an integer from 1 to 10, preferably a number from 1 to 8, particularly preferably from 1 to 5,
   having a trimer content (k=1) of from 60 to 98 mol %, more preferably from 65 to 95 mol %, particularly preferably from 65 to 90 mol % and most particularly preferably from 65 to 85 mol %, in particular from 70 to 85 mol %, based on component C,
and wherein
R is in each case identical or different and represents an amine radical; C1- to C8-alkyl, preferably methyl, ethyl, propyl or butyl, each optionally halogenated, preferably halogenated with fluorine; C1- to C8-alkoxy, preferably methoxy, ethoxy, propoxy or butoxy; C5- to C6-cycloalkyl each optionally substituted by alkyl, preferably C1-C4-alkyl, and/or by halogen, preferably chlorine and/or bromine; C6- to C20-aryloxy, preferably phenoxy, naphthyloxy, each optionally substituted by alkyl, preferably C1-C4-alkyl, and/or by halogen, preferably chlorine, bromine, and/or by hydroxy; C7- to C 12-aralkyl, preferably phenyl-C1-C4-alkyl, each optionally substituted by alkyl, preferably C1-C4-alkyl, and/or by halogen, preferably chlorine and/or bromine; or a halogen radical, preferably chlorine; or an OH radical,
D) from 0 to 15.0 parts by weight, preferably from 2.0 to 12.5 parts by weight, more preferably from 3.0 to 9.0 parts by weight, particularly preferably from 3.0 to 6.0 parts by weight, of rubber-free vinyl (co)polymer or polyalkylene terephthalate,
E) from 0 to 15.0 parts by weight, preferably from 0.05 to 15.00 parts by weight, more preferably from 0.2 to 10.0 parts by weight, particularly preferably from 0.4 to 5.0 parts by weight, of additives,
F) from 0.05 to 5.0 parts by weight, preferably from 0.1 to 2.0 parts by weight, particularly preferably from 0.1 to 1.0 part by weight, of antidripping agents,

wherein all parts by weight are preferably so normalised in the present application that the sum of the parts by weight of all the components A+B+C+D+E+F in the composition is 100.

In a preferred embodiment, the composition consists only of components A to F.

In a preferred embodiment, the composition is free of inorganic flame retardants and flame-retardant synergists, in particular aluminium hydroxide, aluminium oxide hydroxide and arsenic and antimony oxides.

In a preferred embodiment, the composition is free of further organic flame retardants, in particular bisphenol A diphosphate oligomers, resorcinol diphosphate oligomers, triphenyl phosphate, octamethyl-resorcinol diphosphate and tetrabromo-bisphenol A diphosphate oligocarbonate.

The preferred embodiments can be carried out individually or in combination with one another.

The invention likewise provides processes for the production of the moulding compositions, and the use of the moulding compositions in the production of moulded articles, and the use of cyclic phosphazenes with a defined oligomer distribution in the production of the compositions according to the invention.

The moulding compositions according to the invention can be used in the production of moulded articles of any kind. These can be produced by injection moulding, extrusion and blow moulding processes. A further form of processing is the production of moulded articles by deep drawing from previously produced sheets or films.

Examples of such moulded articles are films, profiles, casing parts of any kind, for example for domestic appliances such as juice extractors, coffee machines, mixers; for office machines such as monitors, flat screens, notebooks, printers, copiers; sheets, tubes, conduits for electrical installations, windows, doors and further profiles for the construction sector (interior fitting and external applications) as well as parts for electronics and electrical engineering, such as switches, plugs and sockets, as well as bodywork and interior components for commercial vehicles, in particular for the automotive sector.

In particular, the moulding compositions according to the invention can also be used, for example, in the production of the following moulded articles or mouldings: Parts for the interior finishing of railway vehicles, ships, aircraft, buses and other motor vehicles, casings for electrical devices containing small transformers, casings for devices for processing and transmitting information, casings and coverings for medical devices, casings for security devices, mouldings for sanitary and bathroom fittings, cover grids for ventilator openings, and casings for garden equipment.

Component A

Aromatic polycarbonates and/or aromatic polyester carbonates according to component A that are suitable according to the invention are known in the literature or can be prepared by processes known in the literature (for the preparation of aromatic polycarbonates see, for example, Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; for the preparation of aromatic polyester carbonates see e.g. DE-A 3 007 934).

The preparation of aromatic polycarbonates is carried out, for example, by reaction of diphenols with carbonic acid halides, preferably phosgene, and/or with aromatic dicarboxylic acid dihalides, preferably benzenedicarboxylic acid dihalides, according to the interfacial process, optionally using chain terminators, for example monophenols, and optionally using branching agents having a functionality of three or more than three, for example triphenols or tetraphenols. Preparation by a melt polymerisation process by reaction of diphenols with, for example, diphenyl carbonate is also possible.

Diphenols for the preparation of the aromatic polycarbonates and/or aromatic polyester carbonates are preferably those of formula (I)

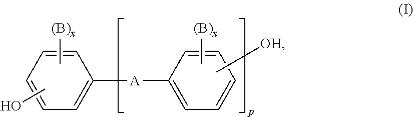

wherein
A is a single bond, C₁- to C₅-alkylene, C₂- to C₅-alkylidene, C₅- to C₆-cyclo-alkylidene, —O—, —SO—, —CO—, —S—, —SO₂—, C₆- to C₁₂-arylene, to which further aromatic rings optionally containing heteroatoms can be fused, or a radical of formula (II) or (III)

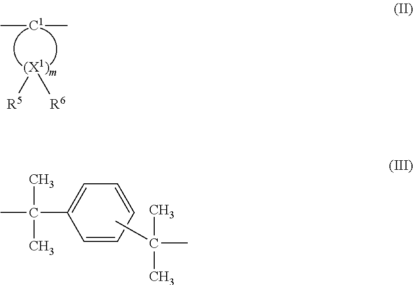

B is in each case C₁- to C₁₂-alkyl, preferably methyl, halogen, preferably chlorine and/or bromine,
x each independently of the other is 0, 1 or 2,
p is 1 or 0, and
R⁵ and R⁶ can be chosen individually for each X¹ and each independently of the other is hydrogen or C₁- to C₆-alkyl, preferably hydrogen, methyl or ethyl,
X¹ is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl)sulfoxides, bis-(hydroxyphenyl)ketones, bis-(hydroxyphenyl)-sulfones and α, α-bis-(hydroxy-phenyl)-diisopropyl-benzenes, and derivatives thereof brominated and/or chlorinated on the ring.

Particularly preferred diphenols are 4,4′-dihydroxydiphenyl, bisphenol A, 2,4-bis(4-hydroxy-phenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenylsulfone and di- and tetra-brominated or chlorinated derivatives thereof, such as, for example, 2,2-bis(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. 2,2-Bis-(4-hydroxyphenyl)-propane (bisphenol A) is particularly preferred.

The diphenols can be used on their own or in the form of arbitrary mixtures. The diphenols are known in the literature or are obtainable according to processes known in the literature.

Chain terminators suitable for the preparation of thermoplastic aromatic polycarbonates are, for example, phenol, p-chlorophenol, p-tert-butylphenol or 2,4,6-tribromophenol, but also long-chained alkylphenols, such as 4-[2-(2,4,4-trimethylpentyl)]-phenol, 4-(1,3-tetramethylbutyl)-phenol according to DE-A 2 842 005 or monoalkylphenol or dialkylphenols having a total of from 8 to 20 carbon atoms in the alkyl substituents, such as 3,5-di-tert-butylphenol, p-isooctylphenol, p-tert-octylphenol, p-dodecylphenol and 2-(3,5-dimethylheptyl)-phenol and 4-(3,5-dimethylheptyl)-phenol. The amount of chain terminators to be used is generally from 0.5 mol % to 10 mol %, based on the molar sum of the diphenols used in a particular case.

The thermoplastic aromatic polycarbonates have mean molecular weights (weight-average M_{w}, measured by GPC (gel permeation chromatography) with polycarbonate standard) of from 15,000 to 80,000 g/mol, preferably from 19,000 to 32,000 g/mol, particularly preferably from 22,000 to 30,000 g/mol.

The thermoplastic aromatic polycarbonates can be branched in a known manner, preferably by the incorporation of from 0.05 to 2.0 mol %, based on the sum of the diphenols used, of compounds having a functionality of three or more than three, for example those having three or more phenolic groups. Preference is given to the use of linear polycarbonates, more preferably based on bisphenol A.

Both homopolycarbonates and copolycarbonates are suitable. For the preparation of copolycarbonates of component A according to the invention it is also possible to use from 1 to 25 wt. %, preferably from 2.5 to 25 wt. %, based on the total amount of diphenols to be used, of polydiorganosiloxanes having hydroxyaryloxy end groups. These are known (U.S. Pat. No. 3,419,634) and can be prepared according to processes known in the literature. Also suitable are copolycarbonates containing polydiorganosiloxanes; the preparation of copolycarbonates containing polydiorganosiloxanes is described, for example, in DE-A 3 334 782.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Mixtures of the diacid dichlorides of isophthalic acid and terephthalic acid in a ratio of from 1:20 to 20:1 are particularly preferred.

In the preparation of polyester carbonates, a carbonic acid halide, preferably phosgene, is additionally used concomitantly as bifunctional acid derivative.

Suitable chain terminators for the preparation of the aromatic polyester carbonates, in addition to the monophenols already mentioned, are also the chlorocarbonic acid esters thereof and the acid chlorides of aromatic monocarboxylic acids, which can optionally be substituted by C₁- to C₂₂-alkyl groups or by halogen atoms, as well as aliphatic C₂- to C₂₂-monocarboxylic acid chlorides.

The amount of chain terminators is in each case from 0.1 to 10 mol %, based in the case of phenolic chain terminators on mol of diphenol and in the case of monocarboxylic acid chloride chain terminators on mol of dicarboxylic acid dichloride.

One or more aromatic hydroxycarboxylic acids can additionally be used in the preparation of aromatic polyester carbonates.

The aromatic polyester carbonates can be both linear and branched in known manner (see in this connection DE-A 2 940 024 and DE-A 3 007 934), linear polyester carbonates being preferred.

There can be used as branching agents, for example, carboxylic acid chlorides having a functionality of three or more, such as trimesic acid trichloride, cyanuric acid trichloride, 3,3′-,4,4′-benzophenone-tetracarboxylic acid tetrachloride, 1,4,5,8-naphthalenetetracarboxylic acid tetrachloride or pyromellitic acid tetrachloride, in amounts of from 0.01 to 1.0 mol % (based on dicarboxylic acid dichlorides used), or phenols having a functionality of three or more, such as phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis [4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytriphenyl)-methyl]-benzene, in amounts of from 0.01 to 1.0 mol %, based on diphenols used. Phenolic branching agents can be placed in a vessel with the diphenols; acid chloride branching agents can be introduced together with the acid dichlorides.

The content of carbonate structural units in the thermoplastic aromatic polyester carbonates can vary as desired. The content of carbonate groups is preferably up to 100 mol %, in particular up to 80 mol %, particularly preferably up to 50 mol %, based on the sum of ester groups and carbonate groups. Both the esters and the carbonates contained in the aromatic polyester carbonates can be present in the polycondensation product in the form of blocks or distributed randomly.

The thermoplastic aromatic polycarbonates and polyester carbonates can be used on their own or in an arbitrary mixture.

Component B

Component B comprises one or more rubber-elastic graft polymers selected from the group consisting of silicone, silicone-acrylate and acrylate rubbers as graft base.

Component B preferably comprises one or more graft polymers prepared by graft reaction of
B.1 from 5 to 95 wt. %, preferably from 20 to 80 wt. %, in particular from 30 to 80 wt. %, of at least one vinyl monomer on
B.2 from 95 to 5 wt. %, preferably from 80 to 20 wt. %, in particular from 70 to 20 wt. %, of one or more graft bases selected from the group consisting of silicone, silicone-acrylate and acrylate rubbers, wherein the glass transition temperature is preferably <10° C., more preferably <0° C., particularly preferably <−20° C.
   The graft base B.2 generally has a mean particle size (d₅₀ value) of from 0.05 to 5 μm, preferably from 0.10 to 0.5 μm, particularly preferably from 0.20 to 0.40 μm.

Monomers B.1 are preferably mixtures of
B.1.1 from 50 to 99 parts by weight, preferably from 60 to 80 parts by weight, of vinyl aromatic compounds and/or vinyl aromatic compounds substituted on the ring (such as, for example, styrene, α-methylstyrene, p-methylstyrene, p-chlorostyrene) and/or (meth)acrylic acid (C₁-C₈)-alkyl esters (such as e.g. methyl methacrylate, ethyl methacrylate) and
B.1.2 from 1 to 50 parts by weight, preferably from 40 to 20 parts by weight, of vinyl cyanides (unsaturated nitriles such as acrylonitrile and methacrylonitrile) and/or (meth)acrylic acid (C₁-C₈)-alkyl esters (such as, for example, methyl methacrylate, n-butyl acrylate, tert-butyl acrylate) and/or derivatives (such as anhydrides and imides) of unsaturated carboxylic acids (for example maleic anhydride and N-phenylmaleimide).

Preferred monomers B.1.1 are selected from at least one of the monomers styrene, α-methylstyrene and methyl methacrylate; preferred monomers B.1.2 are selected from at least one of the monomers acrylonitrile, maleic anhydride and methyl methacrylate.

Particularly preferred monomers are B.1.1 styrene and B.1.2 acrylonitrile.

Silicone rubbers B.2 that are suitable according to the invention consist predominantly of structural units

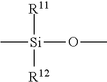

wherein
R11 and R12 can be identical or different and denote C1-C6-alkyl or cycloalkyl or C6-C12-aryl, preferably methyl, ethyl and phenyl.

Preferred silicone rubbers B.2 are particulate with a mean particle diameter d50 of from 0.09 to 1 μm, preferably from 0.09 to 0.4 μm, and a gel content of more than 70 wt. %, in particular from 73 to 98 wt. %, and are obtainable from

1) dihaloorganosilanes

2) from 0 to 10 mol %, based on 1), trihalosilanes, and

3) from 0 to 3 mol %, based on 1), tetrahalosilanes, and

4) from 0 to 0.5 mol %, based on 1), halotriorganosilanes,

wherein the organic radicals in compounds 1), 2), 4) are

α) C1-C6-alkyl or cyclohexyl, preferably methyl or ethyl,

β) C6-C12-aryl, preferably phenyl,

γ) C1-C6-alkenyl, preferably vinyl or allyl,

δ) mercapto-C1-C6-alkyl, preferably mercaptopropyl,

with the proviso that the sum (γ+δ) is from 2 to 10 mol %, based on all the organic radicals of compounds 1), 2) and 4), and the molar ratio γ:δ=from 3:1 to 1:3, preferably from 2:1 to 1:2.

Preferred silicone rubbers B.2 contain as organic radicals at least 80 mol % methyl groups. The end group is generally a diorganyl-hydroxyl-siloxy unit, preferably a dimethylhydroxysiloxy unit.

Preferred silanes 1) to 4) for the production of the silicone rubbers B.2 contain chlorine as halogen substituents.

“Obtainable” means that the silicone rubber B.2 does not necessarily have to be produced from the halogen compounds 1) to 4). Silicone rubbers B.2 having the same structure, which have been produced from silanes having different hydrolysable groups, such as, for example, C1-C6-alkoxy groups, or from cyclic siloxane oligomers, are also to be included.

Silicone graft rubbers are mentioned as a particularly preferred component B.2. These can be produced, for example, by a three-stage process.

In the first stage, monomers such as dimethyldichlorosilane, vinylmethyldichlorosilane or dichlorosilanes are reacted with other substituents to form the cyclic oligomers (octamethylcyclotetrasiloxane or tetravinyltetramethylcyclotetrasiloxane) which are simple to purify by distillation (see Chemie in unserer Zeit 4 (1987), 121-127).

In the second stage, the crosslinked silicone rubbers are obtained from these cyclic oligomers with the addition of mercaptopropylmethyldimethoxysilane by ring-opening cationic polymerisation.

In the third stage, the resulting silicone rubbers, which have graft-active vinyl and mercapto groups, are radically graft-polymerised with vinyl monomers (or mixtures).

In the second stage, preferably mixtures of cyclic siloxane oligomers such as octamethylcyclotetrasiloxane and tetramethyltetravinylcyclotetrasiloxane in emulsion are subjected to ring-opening cationic polymerisation. The silicone rubbers are obtained in particulate form as an emulsion.

It is particularly preferred to work according to GB-PS 1 024 014 with alkylbenzenesulfonic acids, which are active both catalytically and as an emulsifier. After the polymerisation, the acid is neutralised. Instead of alkylbenzenesulfonic acids, n-alkylsulfonic acids can also be used. It is also possible additionally to use co-emulsifiers together with the sulfonic acid.

Co-emulsifiers can be non-ionic or anionic. Suitable anionic co-emulsifiers are in particular salts of n-alkyl- or n-alkylbenzene-sulfonic acids. Non-ionic co-emulsifiers are polyoxyethylene derivatives of fatty alcohols and fatty acids. Examples are POE (3)-lauryl alcohol, POE (20)-oleyl alcohol, POE (7)-nonyl alcohol or POS (10)-stearate. (The notation POE (figure) . . . alcohol means that a number of units of ethylene oxide corresponding to the figure have been added to one molecule of . . . alcohol. POE stands for polyethylene oxide. The figure is a mean value.)

The crosslinking- and graft-active groups (vinyl and mercapto groups, cf. organic radicals γ and δ) can be introduced into the silicone rubber using corresponding siloxane oligomers. These are, for example, tetramethyltetravinylcyclotetrasiloxane or γ-mercaptopropylmethyldimethoxysiloxane or its hydrolysate. They are added to the main oligomer, for example octamethylcyclotetrasiloxane, in the second stage in the desired amounts.

The incorporation of longer-chained alkyl radicals, such as, for example, ethyl, propyl or the like, or the incorporation of phenyl groups can also be achieved analogously.

Sufficient crosslinking of the silicone rubber can already be achieved when the radicals γ and δ react with one another in the emulsion polymerisation, so that the addition of an external crosslinker may be unnecessary. However, a crosslinking silane can be added in the second reaction stage in order to increase the degree of crosslinking of the silicone rubber.

Branchings and crosslinkings can be achieved by addition of, for example, tetraethoxysilane or of a silane of the formula

y-SiX₃,

wherein
X is a hydrolysable group, in particular an alkoxy or halogen radical, and
y is an organic radical.

Preferred silanes y-SiX₃ are methyltrimethoxysilane and phenyltrimethoxysilane.

The gel content is determined at 25° C. in acetone (see DE-AS 2 521 288, col. 6, 1. 17 to 37). In the silicone rubbers according to the invention it is at least 70%, preferably from 73 to 98 wt. %.

Grafted silicone rubbers B can be produced by radical graft polymerisation, for example analogously to DE-PS 2 421 288.

In order to produce the grafted silicone rubber in the third stage, the graft monomers can be radically graft polymerised in the presence of the silicone rubber, in particular at from 40 to 90° C. The graft polymerisation can be carried out in suspension, dispersion or emulsion. Continuous or discontinuous emulsion polymerisation is preferred. This graft polymerisation is carried out with radical initiators (e.g. peroxides, azo compounds, hydroperoxides, persulfates, perphosphates) and optionally with the use of anionic emulsifiers, for example carboxonium salts, sulfonic acid salts or organic sulfates. Graft polymers with high graft yields are thereby formed, that is to say a large proportion of the polymer of the graft monomers is chemically bonded to the silicone rubber. The silicone rubber has graft-active radicals, so that special measures for strong grafting are not required.

The grafted silicone rubbers can be produced by graft polymerisation of from 5 to 95 parts by weight, preferably from 20 to 80 parts by weight, of a vinyl monomer or of a vinyl monomer mixture on from 5 to 95 parts by weight, preferably from 20 to 80 parts by weight, of silicone rubber.

A particularly preferred vinyl monomer is styrene or methyl methacrylate. Suitable vinyl monomer mixtures comprise from 50 to 95 parts by weight of styrene, α-methylstyrene (or other styrenes substituted on the ring by alkyl or halogen) or methyl methacrylate, on the one hand, and from 5 to 50 parts by weight of acrylonitrile, methacrylonitrile, acrylic acid C₁-C₁₈-alkyl esters, methacrylic acid C₁-C₁₆-alkyl esters, maleic anhydride or substituted maleimides, on the other hand. There may additionally be present as further vinyl monomers in smaller amounts acrylic acid esters of primary or secondary aliphatic C₂-C₁₀-alcohols, preferably n-butyl acrylate or acrylic or methylacrylic acid esters of tert-butanol, preferably tert-butyl acrylate. A particularly preferred monomer mixture is from 30 to 40 parts by weight of α-methylstyrene, from 52 to 62 parts by weight of methyl methacrylate and from 4 to 14 parts by weight of acrylonitrile.

The silicone rubbers so grafted can be worked up in known manner, for example by coagulation of the latices with electrolytes (salts, acids or mixtures thereof) and subsequent purification and drying.

In the production of the grafted silicone rubbers, free polymers or copolymers of the graft monomers forming the graft shell are generally formed to a certain degree in addition to the actual graft polymer. The product obtained by polymerisation of the graft monomers in the presence of the silicone rubber is here grafted silicone rubber, to be precise, therefore, generally a mixture of graft copolymer and free (co)polymer of the graft monomers.

Graft polymers according to component B based on acrylate rubber are preferably obtainable by graft reaction of
(a) from 20 to 90 wt. %, based on the graft polymer, of acrylate rubber, preferably having a glass transition temperature below −20° C., as graft base and
(b) from 10 to 80 wt. %, based on the graft polymer, of at least one polymerisable, ethylenically unsaturated monomer (see B.1) as graft monomer.

The acrylate rubbers (a) are preferably polymers of acrylic acid alkyl esters, optionally with up to 40 wt. %, based on (a), of other polymerisable, ethylenically unsaturated monomers. The preferred polymerisable acrylic acid esters include C₁-C₈-alkyl esters, for example methyl, ethyl, butyl, n-octyl and 2-ethylhexyl ester; haloalkyl esters, preferably halo-C₁-C₈-alkyl esters, such as chloroethyl acrylate, and mixtures of these monomers.

For crosslinking, monomers with more than one polymerisable double bond can be copolymerised. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as, for example, ethylene glycol dimethacrylate, allyl methacrylate; polyunsaturated heterocyclic compounds, such as, for example, trivinyl and triallyl cyanurate; polyfunctional vinyl compounds, such as di- and tri-vinylbenzenes; but also triallyl phosphate and diallyl phthalate.

Preferred crosslinking monomers are allyl methacrylate, ethylene glycol dimethacrylate, diallyl phthalate and heterocyclic compounds which contain at least 3 ethylenically unsaturated groups.

Particularly preferred crosslinking monomers are the cyclic monomers triallyl cyanurate, triallyl isocyanurate, triacryloylhexahydro-s-triazine, triallylbenzenes.

The amount of crosslinking monomers is preferably from 0.02 to 5 wt. %, in particular from 0.05 to 2 wt. %, based on the rubber base.

In the case of cyclic crosslinking monomers having at least 3 ethylenically unsaturated groups, it is advantageous to limit the amount to less than 1 wt. % of the rubber base.

Preferred “other” polymerisable, ethylenically unsaturated monomers which can optionally be used in addition to the acrylic acid esters for preparing the graft base B.2 are, for example, acrylonitrile, styrene, α-methylstyrene, acrylamides, vinyl C₁-C₆-alkyl ethers, methyl methacrylate, butadiene. Preferred acrylate rubbers as the graft base B.2 are emulsion polymers which have a gel content of at least 60 wt. %.

The acrylate-based polymers are generally known, can be prepared by known processes (e.g. EP-A 244 857) or are commercial products.

The gel content of the graft base is determined at 25° C. in a suitable solvent (M. Hoffmann, H. Krömer, R. Kuhn, Polymeranalytik I und II, Georg Thieme-Verlag, Stuttgart 1977).

The mean particle size d₅₀ is the diameter above and below which in each case 50 wt. % of the particles lie. It can be determined by means of ultracentrifuge measurement (W. Scholtan, H. Lange, Kolloid, Z. und Z. Polymere 250 (1972), 782-1796).

Unless indicated otherwise in the present invention, glass transition temperatures are determined by means of differential scanning calorimetry (DSC) according to standard DIN EN 61006 at a heating rate of 10 K/min with definition of the Tg as the mid-point temperature (tangent method) and nitrogen as protecting gas.

Component B preferably comprises one or more graft polymers produced by graft reaction of
B.1 from 5 to 95 wt. %, preferably from 7 to 50 wt. %, particularly preferably from 9 to 30 wt. %, of one or more vinyl monomers on
B.2 from 95 to 5 wt. %, preferably from 93 to 50 wt. %, particularly preferably from 91 to 70 wt. %, of one or more silicone-acrylate composite rubbers as graft base,

the silicone-acrylate rubber comprising
B.2.1 from 5 to 75 wt. %, preferably from 7 to 50 wt. %, particularly preferably from 9 to 40 wt. %, silicone rubber and
B.2.2 from 95 to 25 wt. %, preferably from 93 to 50 wt. %, particularly preferably from 91 to 60 wt. %, polyalkyl (meth)acrylate rubber,

wherein the two mentioned rubber components B.2.1 and B.2.2 interpenetrate in the composite rubber so that they are substantially inseparable from one another.

The graft copolymers B are produced by radical polymerisation, for example by emulsion, suspension, solution or mass polymerisation, preferably by emulsion or mass polymerisation.

Suitable monomers B.1 are vinyl monomers such as vinyl aromatic compounds and/or vinyl aromatic compounds substituted on the ring (such as styrene, α-methylstyrene, p-methylstyrene, p-chlorostyrene), methacrylic acid (C₁-C₈)-alkyl esters (such as methyl methacrylate, ethyl methacrylate, 2-ethylhexyl methacrylate, allyl methacrylate), acrylic acid (C₁-C₈)-alkyl esters (such as methyl acrylate, ethyl acrylate, n-butyl acrylate, tert-butyl acrylate), organic acids (such as acrylic acid, methacrylic acid) and/or vinyl cyanides (such as acrylonitrile and methacrylonitrile) and/or derivatives (such as anhydrides and imides) of unsaturated carboxylic acids (for example maleic anhydride and N-phenyl-maleimide). These vinyl monomers can be used on their own or in mixtures of at least two monomers.

Preferred monomers B.1 are selected from at least one of the monomers styrene, α-methylstyrene, methyl methacrylate, n-butyl acrylate and acrylonitrile. Methyl methacrylate is particularly preferably used as the monomer B.1.

The glass transition temperature of the graft base B.2 is preferably <10° C., more preferably <0° C., particularly preferably <−20° C.

The graft base B.2 generally has a mean particle size (d₅₀ value) of from 0.05 to 10 μm, preferably from 0.06 to 5 μm, particularly preferably from 0.08 to 1 μm.

The silicone-acrylate rubbers are known and described, for example, in U.S. Pat. No. 5,807,914, EP 430134 and U.S. Pat. No. 4,888,388.

Suitable silicone rubber components of the silicone-acrylate rubbers are silicone rubbers having graft-active sites, whose production method is described, for example, in U.S. Pat. No. 2,891,920, U.S. Pat. No. 3,294,725, DE-OS 3 631 540, EP 249964, EP 430134 and U.S. Pat. No. 4,888,388.

The silicone rubber is preferably produced by emulsion polymerisation, in which siloxane monomer structural units, crosslinkers or branching agents (IV) and optionally grafting agents (V) are used.

There are used as the siloxane monomer structural units, for example and preferably, dimethylsiloxane or cyclic organosiloxanes having at least 3 ring members, preferably from 3 to 6 ring members, such as, for example and preferably, hexamethylcyclotrisiloxane, octa-methylcyclotetrasiloxane, decamethylcyclopentasiloxane, dodecamethylcyclohexasiloxane, trimethyl-triphenyl-cyclotrisiloxane, tetramethyl-tetraphenyl-cyclotetrasiloxane, octaphenylcyclo-tetrasiloxane. The organosiloxane monomers can be used on their own or in the form of mixtures of 2 or more monomers. The silicone rubber preferably contains not less than 50 wt. % and particularly preferably not less than 60 wt. % organosiloxane, based on the total weight of the silicone rubber component.

As crosslinkers or branching agents (IV) there are preferably used silane-based crosslinkers having a functionality of 3 or 4, particularly preferably 4. Preferred examples which may be mentioned include: trimethoxymethylsilane, triethoxyphenylsilane, tetramethoxysilane, tetraethoxysilane, tetra-n-propoxysilane and tetrabutoxysilane. The crosslinker can be used on its own or in a mixture of two or more. Tetraethoxysilane is particularly preferred.

The crosslinker is used in an amount in the range from 0.1 to 40 wt. %, based on the total weight of the silicone rubber component. The amount of crosslinker is so chosen that the degree of swelling of the silicone rubber, measured in toluene, is from 3 to 30, preferably from 3 to 25 and particularly preferably from 3 to 15. The degree of swelling is defined as the weight ratio of the amount of toluene absorbed by the silicone rubber when it is saturated with toluene at 25° C. and the amount of silicone rubber in the dry state. The determination of the degree of swelling is described in detail in EP 249964.

If the degree of swelling is less than 3, that is to say if the content of crosslinker is too high, the silicone rubber does not have adequate rubber elasticity. If the swelling index is greater than 30, the silicone rubber is unable to form domain structures in the matrix polymer and therefore cannot improve impact strength either; the effect would then be similar to that of simply adding polydimethylsiloxane.

Tetrafunctional branching agents are preferred to trifunctional branching agents because the degree of swelling can then more easily be controlled within the above-described limits.

Suitable grafting agents (V) are compounds that are capable of forming structures of the following formulae:

CH₂═C(R²)—COO—(CH₂)ₚ—SiR¹ₙO_{(3-n)/2} (V-2)

CH₂═CH—SiR¹ₙO_{(3-n)/2} (V-2) or

HS—(CH₂)ₚ—SiR¹ₙO_{(3-n)/2} (V-3)

wherein

R¹ represents C₁-C₄-alkyl, preferably methyl, ethyl or propyl, or phenyl,

R² represents hydrogen or methyl,

n denotes 0, 1 or 2 and

p denotes an integer from 1 to 6.

Acryloyl- or methacryloyl-oxysilanes are particularly suitable for forming the above-mentioned structure (V-1) and have a high grafting efficiency. Effective formation of the graft chains is thereby ensured, and the impact strength of the resulting resin composition is accordingly promoted.

Preferred examples which may be mentioned include: β-methacryloyloxy-ethyldimethoxymethyl-silane, γ-methacryloyloxy-propylmethoxydimethyl-silane, γ-methacryloyloxy-propyldimethoxy-methyl-silane, γ-methacryloyloxy-propyltrimethoxy-silane, γ-methacryloyloxy-propylethoxy-diethyl-silane, γ-methacryloyloxy-propyldiethoxymethyl-silane, δ-methacryloyl-oxy-butyldi-ethoxymethyl-silane or mixtures thereof.

Preferably from 0 to 20 wt. % of grafting agent, based on the total weight of the silicone rubber, is used.

Suitable polyalkyl (meth)acrylate rubber components of the silicone-acrylate rubbers can be prepared from methacrylic acid alkyl esters and/or acrylic acid alkyl esters, a crosslinker (VI) and a grafting agent (VII). Examples of preferred methacrylic acid alkyl esters and/or acrylic acid alkyl esters include the C₁- to C₈-alkyl esters, for example methyl, ethyl, n-butyl, tert-butyl, n-propyl, n-hexyl, n-octyl, n-lauryl and 2-ethylhexyl esters; haloalkyl esters, preferably halo-C₁-C₈-alkyl esters, such as chloroethyl acrylate, and mixtures of these monomers. n-Butyl acrylate is particularly preferred.

As crosslinkers (VI) for the polyalkyl (meth)acrylate rubber component of the silicone-acrylate rubber there can be used monomers having more than one polymerisable double bond. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as ethylene glycol dimethacrylate, propylene glycol dimethacrylate, 1,3-butylene glycol dimethacrylate and 1,4-butylene glycol dimethacrylate. The crosslinkers can be used on their own or in mixtures of at least two crosslinkers.

Examples of preferred grafting agents (VII) include allyl methacrylate, triallyl cyanurate, triallyl isocyanurate or mixtures thereof. Allyl methacrylate can also be used as crosslinker (VI). The grafting agents can be used on their own or in mixtures of at least two grafting agents.

The amount of crosslinker (VI) and grafting agent (VII) is from 0.1 to 20 wt. %, based on the total weight of the polyalkyl (meth)acrylate rubber component of the silicone-acrylate rubber.

The silicone-acrylate rubber is produced by first preparing the silicone rubber in the form of an aqueous latex. The silicone rubber can be prepared by emulsion polymerisation, as described, for example, in U.S. Pat. No. 2,891,920 and U.S. Pat. No. 3,294,725. To that end, a mixture containing organosiloxane, crosslinker and optionally grafting agent is mixed with water, with shearing, for example by means of a homogeniser, in the presence of an emulsifier based on sulfonic acid, such as, for example, alkylbenzenesulfonic acid or alkylsulfonic acid, the mixture polymerising completely to give the silicone rubber latex. An alkylbenzenesulfonic acid is particularly suitable because it acts not only as an emulsifier but also as a polymerisation initiator. In this case, a combination of the sulfonic acid with a metal salt of an alkylbenzenesulfonic acid or with a metal salt of an alkylsulfonic acid is advantageous because the polymer is thereby stabilised during the subsequent graft polymerisation.

After the polymerisation, the reaction is ended by neutralising the reaction mixture by adding an aqueous alkaline solution, for example by adding an aqueous sodium hydroxide, potassium hydroxide or sodium carbonate solution.

The latex is then enriched with the methacrylic acid alkyl esters and/or acrylic acid alkyl esters that are to be used, the crosslinker (VI) and the grafting agent (VII), and a polymerisation is carried out. Preference is given to an emulsion polymerisation initiated by radicals, for example by a peroxide, an azo or a redox initiator. Particular preference is given to the use of a redox initiator system, especially of a sulfoxylate initiator system prepared by combining iron sulfate, disodium ethylenediaminetetraacetate, rongalite and hydroperoxide.

The grafting agent (V) that is used in the preparation of the silicone rubber has the effect of bonding the polyalkyl (meth)acrylate rubber component covalently to the silicone rubber component. In the polymerisation, the two rubber components interpenetrate and thus form the composite rubber, which can no longer be separated into its constituents of silicone rubber component and polyalkyl (meth)acrylate rubber component after the polymerisation.

For the production of the silicone-acrylate graft rubbers B, the monomers B.1 are grafted on to the rubber base B.2.

The polymerisation methods described in EP 249964, EP 430134 and U.S. Pat. No. 4,888,388 can be used, for example.

For example, the graft polymerisation is carried out according to the following polymerisation method: In a single- or multi-stage emulsion polymerisation initiated by radicals, the desired vinyl monomers B.1 are polymerised on to the graft base, which is present in the form of an aqueous latex. The grafting efficiency should thereby be as high as possible and is preferably greater than or equal to 10%. The grafting efficiency is significantly dependent on the grafting agent (V) or (VII) that is used. After the polymerisation to the silicone-acrylate graft rubber, the aqueous latex is added to hot water in which metal salts, such as, for example, calcium chloride or magnesium sulfate, have previously been dissolved. The silicone-acrylate graft rubber thereby coagulates and can subsequently be separated.

Component C

Phosphazenes according to component C which are used according to the present invention are cyclic phosphazenes according to formula (X)

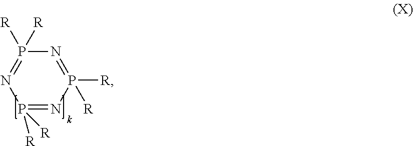

wherein
R is in each case identical or different and represents
   an amine radical,
   C1- to C₈-alkyl, preferably methyl, ethyl, propyl or butyl, each optionally halogenated, preferably halogenated with fluorine, more preferably monohalogenated,
   C₁- to C₈-alkoxy, preferably methoxy, ethoxy, propoxy or butoxy,
   C₅- to C₆-cycloalkyl each optionally substituted by alkyl, preferably C₁-C₄-alkyl, and/or by halogen, preferably chlorine and/or bromine,
   C₆- to C₂₀-aryloxy, preferably phenoxy, naphthyloxy, each optionally substituted by alkyl, preferably C₁-C₄-alkyl, and/or by halogen, preferably chlorine, bromine, and/or by hydroxy,
   C₇- to C₁₂-aralkyl, preferably phenyl-C₁-C₄-alkyl, each optionally substituted by alkyl, preferably C₁-C₄-alkyl, and/or by halogen, preferably chlorine and/or bromine, or
   a halogen radical, preferably chlorine or fluorine, or
   an OH radical,
k has the meaning mentioned above.

Preference is given to:

propoxyphosphazene, phenoxyphosphazene, methylphenoxyphosphazene, aminophosphazene and fluoroalkylphosphazenes, as well as phosphazenes having the following structures:

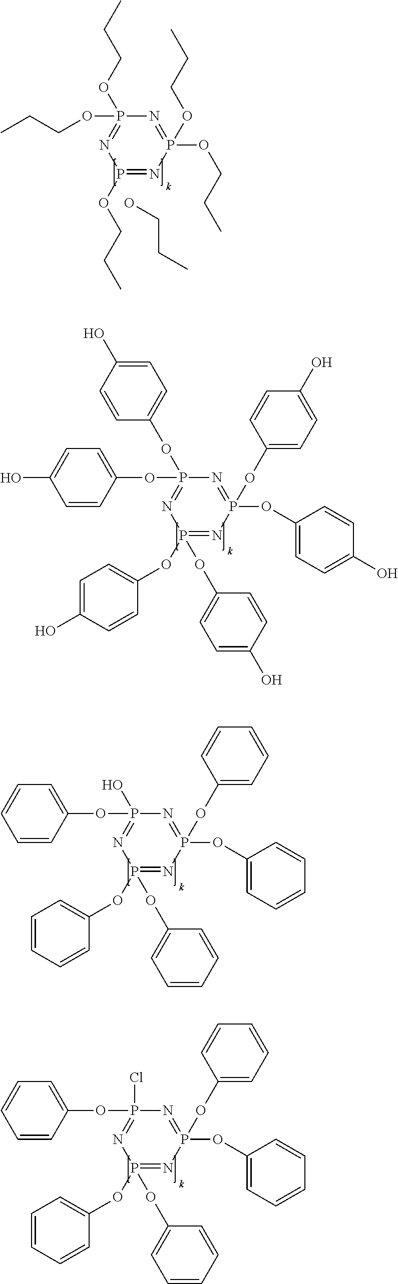

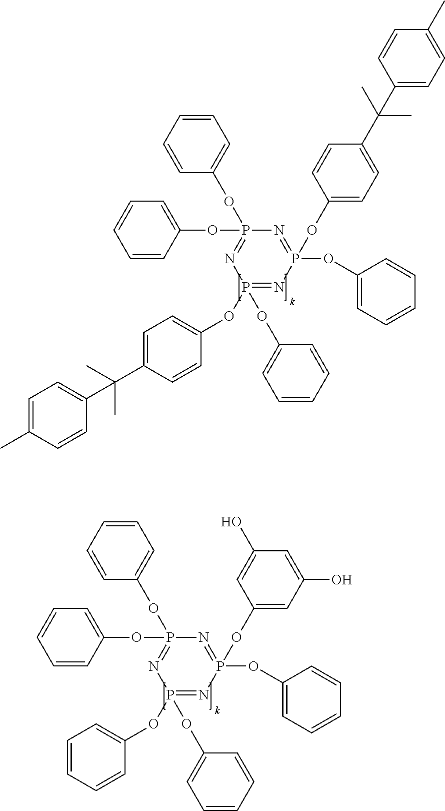

In the compounds shown above, k=1, 2 or 3.

Preference is given to phenoxyphosphazene (all R=phenoxy) having a content of oligomers with k=1 (C1) of from 60 to 98 mol %.

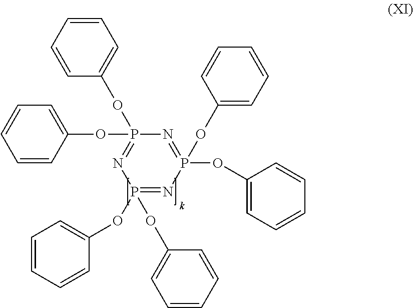

In the case where the phosphazene according to formula (X) is halo-substituted on the phosphorus, for example from incompletely reacted starting material, the content of this phosphazene halo-substituted on the phosphorus is preferably less than 1000 ppm, more preferably less than 500 ppm.

The phosphazenes can be used on their own or in the form of a mixture, that is to say the radical R can be identical or two or more radicals of formula (X) can be different. The radicals R of a phosphazene are preferably identical.

In a further preferred embodiment, only phosphazenes with identical R are used.

In a preferred embodiment, the content of tetramers (k=2) (C2) is from 2 to 50 mol %, based on component C, more preferably from 5 to 40 mol %, yet more preferably from 10 to 30 mol %, particularly preferably from 10 to 20 mol %.

In a preferred embodiment, the content of higher oligomeric phosphazenes (k=3, 4, 5, 6 and 7) (C3) is from 0 to 30 mol %, based on component C, more preferably from 2.5 to 25 mol %, yet more preferably from 5 to 20 mol % and particularly preferably from 6 to 15 mol %.

In a preferred embodiment, the content of oligomers with k>=8 (C4) is from 0 to 2.0 mol %, based on component C, and preferably from 0.10 to 1.00 mol %.

In a further preferred embodiment, the phosphazenes of component C fulfil all three conditions mentioned above as regards the contents (C2-C4).

Component C is preferably a phenoxyphosphazene with a trimer content (k=1) of from 65 to 85 mol %, a tetramer content (k=2) of from 10 to 20 mol %, a content of higher oligomeric phosphazenes (k=3, 4, 5, 6 and 7) of from 5 to 20 mol % and of phosphazene oligomers with k>=8 of from 0 to 2 mol %, based on component C.

Component C is particularly preferably a phenoxyphosphazene with a trimer content (k=1) of from 70 to 85 mol %, a tetramer content (k=2) of from 10 to 20 mol %, a content of higher oligomeric phosphazenes (k=3, 4, 5, 6 and 7) of from 6 to 15 mol % and of phosphazene oligomers with k>=8 of from 0.1 to 1 mol %, based on component C.

In a further particularly preferred embodiment, component C is a phenoxyphosphazene with a trimer content (k=1) of from 65 to 85 mol %, a tetramer content (k=2) of from 10 to 20 mol %, a content of higher oligomeric phosphazenes (k=3, 4, 5, 6 and 7) of from 5 to 15 mol % and of phosphazene oligomers with k>=8 of from 0 to 1 mol %, based on component C.

n defines the weighted arithmetic mean of k according to the following formula:

$$n = \frac{{\sum }_{i = 1}^{max} ki \cdot xi}{{\sum }_{i = 1}^{max} xi}$$

where xᵢ is the content of the oligomer kᵢ, and the sum of all xᵢ is accordingly 1.

In an alternative embodiment, n is in the range from 1.10 to 1.75, preferably from 1.15 to 1.50, more preferably from 1.20 to 1.45, and particularly preferably from 1.20 to 1.40 (including the limits of the ranges).

The phosphazenes and their preparation are described, for example, in EP-A 728 811, DE-A 1 961668 and WO 97/40092.

The oligomer compositions of the phosphazenes in the blend samples can also be detected and quantified, after compounding, by means of ³¹P NMR (chemical shift; δ trimer: 6.5 to 10.0 ppm; δ tetramer: −10 to −13.5 ppm; δ higher oligomers: −16.5 to −25.0 ppm).

Component D

Component D comprises one or more thermoplastic vinyl (co)polymers or polyalkylene terephthalates.

Suitable as vinyl (co)polymers D are polymers of at least one monomer from the group of the vinyl aromatic compounds, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. Particularly suitable are (co)polymers of
D.1 from 50 to 99 parts by weight, preferably from 60 to 80 parts by weight, of vinyl aromatic compounds and/or vinyl aromatic compounds substituted on the ring (such as styrene, α-methylstyrene, p-methylstyrene, p-chlorostyrene) and/or (meth)acrylic acid (C₁-C₈)-alkyl esters (such as methyl methacrylate, ethyl methacrylate), and
D.2 from 1 to 50 parts by weight, preferably from 20 to 40 parts by weight, of vinyl cyanides (unsaturated nitriles), such as acrylonitrile and methacrylonitrile, and/or (meth)acrylic acid (C₁-C₈)-alkyl esters, such as methyl methacrylate, n-butyl acrylate, tert-butyl acrylate, and/or unsaturated carboxylic acids, such as maleic acid, and/or derivatives, such as anhydrides and imides, of unsaturated carboxylic acids (for example maleic anhydride and N-phenylmaleimide).

The vinyl (co)polymers D are resin-like, thermoplastic and rubber-free. Particular preference is given to the copolymer of D.1 styrene and D.2 acrylonitrile.

The (co)polymers according to D are known and can be prepared by radical polymerisation, in particular by emulsion, suspension, solution or mass polymerisation. The (co)polymers preferably have mean molecular weights Mw (weight-average, determined by light scattering or sedimentation) of from 15,000 to 200,000 g/mol, particularly preferably from 100,000 to 150,000 g/mol.

In a particularly preferred embodiment, D is a copolymer of 77 wt. % styrene and 23 wt. % acrylonitrile with a weight-average molecular weight M_{w}, of 130,000 g/mol.

Suitable as component D the compositions comprise according to the invention one or a mixture of two or more different polyalkylene terephthalates.

Polyalkylene terephthalates within the scope of the invention are polyalkylene terephthalates which are derived from terephthalic acid (or reactive derivatives, e.g. dimethyl esters or anhydrides, thereof) and alkanediols, cycloaliphatic or araliphatic diols and mixtures thereof, for example based on propylene glycol, butanediol, pentanediol, hexanediol, 1,2-cyclohexanediol, 1,4-cyclohexanediol, 1,3-cyclohexanediol and cyclohexyldimethanol, wherein the diol component according to the invention contains more than 2 carbon atoms. Accordingly, there are used as component D preferably polybutylene terephthalate and/or polytrimethylene terephthalate, most preferably polybutylene terephthalate.

The polyalkylene terephthalates according to the invention can comprise as the monomer of the diacid also up to 5 wt. % isophthalic acid.

Preferred polyalkylene terephthalates can be prepared by known methods from terephthalic acid (or reactive derivatives thereof) and aliphatic or cycloaliphatic diols having from 3 to 21 carbon atoms (Kunststoff-Handbuch, Vol. VIII, p. 695 ff, Karl-Hanser-Verlag, Munich 1973).

Preferred polyalkylene terephthalates comprise at least 80 mol %, preferably at least 90 mol %, based on the diol component, 1,3-propanediol and/or 1,4-butanediol radicals.

As well as comprising terephthalic acid radicals, the preferred polyalkylene terephthalates can comprise up to 20 mol % of radicals of other aromatic dicarboxylic acids having from 8 to 14 carbon atoms or of aliphatic dicarboxylic acids having from 4 to 12 carbon atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid.

As well as comprising 1,3-propanediol or 1,4-butanediol radicals, the preferred polyalkylene terephthalates can comprise up to 20 mol % of other aliphatic diols having from 3 to 12 carbon atoms or cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol and 2-ethyl-1,6-hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetra-methyl-cyclobutane, 2,2-bis-(3-β-hydroxyethoxyphenyl)-propane and 2,2-bis-(4-hydroxypropoxy-phenyl)-propane (DE-A 24 07 674, 24 07 776, 27 15 932).

The polyalkylene terephthalates can be branched by incorporation of relatively small amounts of tri- or tetra-hydric alcohols or tri- or tetra-basic carboxylic acids, as are described, for example, in DE-A 19 00 270 and U.S. Pat. No. 3,692,744. Examples of preferred branching agents are trimesic acid, trimellitic acid, trimethylol-ethane and -propane and pentaerythritol.

It is advisable to use not more than 1 mol % of the branching agent, based on the acid component.

Particular preference is given to polyalkylene terephthalates that have been prepared solely from terephthalic acid or reactive derivatives thereof (e.g. dialkyl esters thereof, such as dimethyl terephthalate) and 1,3-propanediol and/or 1,4-butanediol (polypropylene and polybutylene terephthalate) and mixtures of such polyalkylene terephthalates.

Preferred polyalkylene terephthalates are also copolyesters prepared from at least two of the above-mentioned acid components and/or from at least two of the above-mentioned alcohol components, particularly preferred copolyesters are poly-(1,3-propylene glycol/1,4-butanediol) terephthalates.

The polyalkylene terephthalates generally have an intrinsic viscosity of approximately from 0.4 to 1.5 dl/g, preferably from 0.5 to 1.3 dl/g, in each case measured in phenol/o-dichlorobenzene (1:1 parts by weight) at 25° C.

In an alternative embodiment, the polyesters prepared according to the invention can also be used in admixture with other polyesters and/or further polymers, preference being given here to the use of mixtures of polyalkylene terephthalates with other polyesters.

Further Additives E

The composition can comprise further conventional polymer additives, such as flame-retardant synergists other than antidripping agents, lubricants and demoulding agents (for example pentaerythritol tetrastearate), nucleating agents, stabilisers (for example UV/light stabilisers, heat stabilisers, antioxidants, transesterification inhibitors, hydrolytic stabilisers), antistatics (for example conductive blacks, carbon fibres, carbon nanotubes as well as organic antistatics such as polyalkylene ethers, alkyl sulfonates or polyamide-containing polymers) as well as colourants, pigments, fillers and reinforcing materials, in particular glass fibres, mineral reinforcing materials and carbon fibres.

There are preferably used as stabilisers sterically hindered phenols and phosphites or mixtures thereof, such as, for example, Irganox® B900 (Ciba Speciality Chemicals). Pentaerythritol tetrastearate is preferably used as the demoulding agent. Carbon black is further preferably used as a black pigment (e.g. Blackpearls).

As well as comprising optional further additives, particularly preferred moulding compositions comprise as component E a demoulding agent, particularly preferably pentaerythritol tetrastearate, in an amount of from 0.1 to 1.5 parts by weight, preferably from 0.2 to 1.0 part by weight, particularly preferably from 0.3 to 0.8 part by weight. As well as comprising optional further additives, particularly preferred moulding compositions comprise as component E at least one stabiliser, for example selected from the group of the sterically hindered phenols, phosphites and mixtures thereof and particularly preferably Irganox® B900, in an amount of from 0.01 to 0.5 part by weight, preferably from 0.03 to 0.4 part by weight, particularly preferably from 0.06 to 0.3 part by weight.

The combination of PTFE (component F), pentaerythritol tetrastearate and Irganox B900 with a phosphorus-based flame retardant as component C) is also particularly preferred.

Component F

There are used as antidripping agents in particular polytetrafluoroethylene (PTFE) or PTFE-containing compositions such as, for example, masterbatches of PTFE with styrene- or methyl-methacrylate-containing polymers or copolymers, in the form of powders or in the form of a coagulated mixture, for example with component B.

The fluorinated polyolefins used as antidripping agents have a high molecular weight and have glass transition temperatures of over −30° C., generally over 100° C., fluorine contents of preferably from 65 to 76 wt. %, in particular from 70 to 76 wt. %, mean particle diameters d₅₀ of from 0.05 to 1000 μm, preferably from 0.08 to 20 μm. In general, the fluorinated polyolefins have a density of from 1.2 to 2.3 g/cm³. Preferred fluorinated polyolefins are polytetrafluoroethylene, polyvinylidene fluoride, tetrafluoroethylene/hexafluoropropylene and ethylene/tetrafluoroethylene copolymers. The fluorinated polyolefins are known (see “Vinyl and Related Polymers” by Schildknecht, John Wiley & Sons, Inc., New York, 1962, pages 484-494; “Fluorpolymers” by Wall, Wiley-Interscience, John Wiley & Sons, Inc., New York, Volume 13, 1970, pages 623-654; “Modern Plastics Encyclopedia”, 1970-1971, Volume 47, No. 10 A, October 1970, McGraw-Hill, Inc., New York, pages 134 and 774; “Modern Plastics Encyclopedia”, 1975-1976, October 1975, Volume 52, No. 10 A, McGraw-Hill, Inc., New York, pages 27, 28 and 472 and U.S. Pat. Nos. 3,671,487, 3,723,373 and 3,838,092).

They can be prepared by known processes, for example by polymerisation of tetrafluoroethylene in an aqueous medium with a free-radical-forming catalyst, for example sodium, potassium or ammonium peroxodisulfate, at pressures of from 7 to 71 kg/cm² and at temperatures of from 0 to 200° C., preferably at temperatures of from 20 to 100° C. (For further details see e.g. U.S. Pat. No. 2,393,967.) Depending on the form in which they are used, the density of these materials can be from 1.2 to 2.3 g/cm³, and the mean particle size can be from 0.05 to 1000 μm.

The fluorinated polyolefins that are preferred according to the invention have mean particle diameters of from 0.05 to 20 μm, preferably from 0.08 to 10 μm, and density of from 1.2 to 1.9 g/cm³.

Suitable fluorinated polyolefins F which can be used in powder form are tetrafluoroethylene polymers having mean particle diameters of from 100 to 1000 μm and densities of from 2.0 g/cm³ to 2.3 g/cm³. Suitable tetrafluoroethylene polymer powders are commercial products and are supplied, for example, by DuPont under the trade name Teflon®.

As well as comprising optional further additives, particularly preferred flame-retardant compositions comprise as component F a fluorinated polyolefin in an amount of from 0.05 to 5.0 parts by weight, preferably from 0.1 to 2.0 parts by weight, particularly preferably from 0.3 to 1.0 part by weight.

The examples which follow serve to explain the invention further.

Component A1

Linear polycarbonate based on bisphenol A with a weight-average molecular weight Mw of 27,500 g/mol (determined by GPC in dichloromethane with polycarbonate as standard).

Component A2

Linear polycarbonate based on bisphenol A with a weight-average molecular weight Mw of 25,000 g/mol (determined by GPC in dichloromethane with polycarbonate as standard).

Component B

B1

Graft polymer prepared by reaction of 14 wt. % methyl methacrylate on 86 wt. % of a silicone-acrylate composite rubber as graft base, the silicone-acrylate rubber comprising 36 wt. % silicone rubber and 64 wt. % polyalkyl (meth)acrylate rubber and the two mentioned rubber components interpenetrating in the composite rubber so that they are substantially inseparable from one another.

B2

Graft polymer prepared by reaction of 17 wt. % methyl methacrylate on 83 wt. % of a silicone-acrylate composite rubber as graft base, the silicone-acrylate rubber comprising 11 wt. % silicone rubber and 89 wt. % polyalkyl (meth)acrylate rubber and the two mentioned rubber components interpenetrating in the composite rubber so that they are substantially inseparable from one another.

B3

Graft polymer prepared by reaction of 30 wt. % methyl methacrylate on 70 wt. % of a butyl acrylate rubber as graft base prepared by emulsion polymerisation.

Component C1

Phenoxyphosphazene of formula (XI) having a content of oligomers with k=1 of 70 mol %, a content of oligomers with k=2 of 18 mol % and a content of oligomers with k≧3 of 12 mol %.

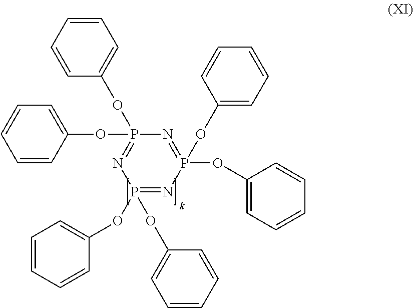

Component C2

Bisphenol-A-based oligophosphate having a phosphorus content of 8.9% (BDP).

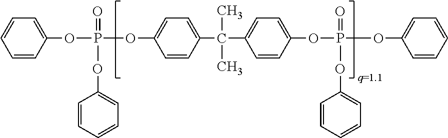

Component D

Copolymer of 77 wt. % styrene and 23 wt. % acrylonitrile with a weight-average molecular weight Mw of 130 kg/mol (determined by GPC), prepared by the mass process.

Component E1

Pentaerythritol tetrastearate as lubricant/demoulding agent.

Component E2

Heat stabiliser, Irganox® B900 (mixture of 80% Irgafos® 168 and 20% Irganox® 1076; BASF AG; Ludwigshafen/Irgafos® 168 (tris(2,4-di-tert-butyl-phenyl)phosphite)/Irganox® 1076 (2,6-di-tert-butyl-4-(octadecanoxycarbonylethyl)phenol).

Component F1

Polytetrafluoroethylene powder, CFP 6000 N, Du Pont

Component F2

Coagulated mixture of emulsions of fluorinated polyolefins with emulsions of a copolymer based on styrene/acrylonitrile (in each case 50 wt. %) (Cycolac INP 449 from Sabic).

Preparation and Testing of the Moulding Compositions

The substances listed in Table 1 are compounded at a speed of 225 rpm and with a throughput of 20 kg/h, at a machine temperature of 260° C., on a twin-screw extruder (ZSK-25) (Werner and Pfleiderer) and granulated.

The finished granules are processed on an injection-moulding machine to the corresponding test specimens (melt temperature 240° C., tool temperature 80° C., flow front speed 240 mm/s).

In order to characterise the properties of the materials, the following methods were used:

The IZOD notched impact strength was measured in accordance with ISO 180/1A on test bars of dimensions 80 mm×10 mm×4 mm overmoulded on one side.

The joint line strength anF was measured in accordance with ISO 179/1eU on a test bar of dimensions 80×10×4 mm overmoulded on both sides.

The behaviour in fire is measured in accordance with UL 94V on bars measuring 127×12.7×1.5 mm.

The heat distortion resistance was measured in accordance with ISO 306 (Vicat softening temperature, method B with 50 N load and a heating rate of 120 Kh) on test bars of dimensions 80 mm×10 mm×4 mm overmoulded on one side.

The stress cracking behaviour (ESC behaviour) was tested on bars measuring 80×10×4 mm, processing temperature 240° C. Rape oil was used as the test medium. The test specimens were pre-stressed (pre-stressing in percent) by means of a circular arc template and stored at room temperature in the test medium. The stress cracking behaviour was evaluated as the time spent in the test medium before crack formation or fracture occurred.

TABLE 1
Composition and properties of the moulding compositions

| | | | | | | Ex. 6 |
|---|---|---|---|---|---|---|
| | Ex. 1 | Ex. 2 | Ex. 3 | Ex. 4 | Ex. 5 | (comp.) |
| Components (parts by weight) | | | | | | |
| A1 | | | | 83.2 | 83.2 | 83.2 |
| A2 | 94.4 | 94.4 | 94.4 | | | |
| B1 | 2.2 | | | 9 | | 9 |
| B2 | | 2.2 | | | 9 | |
| B3 | | | 2.2 | | | |
| C1 | 2.5 | 2.5 | 2.5 | 6.5 | 6.5 | |
| C2 | | | | | | 6.5 |
| F1 | 0.4 | 0.4 | 0.4 | | | |
| F2 | | | | 0.8 | 0.8 | 0.8 |
| E1 | 0.4 | 0.4 | 0.4 | 0.4 | 0.4 | 0.4 |
| E2 | 0.1 | 0.1 | 0.1 | 0.1 | 0.1 | 0.1 |
| Properties | | | | | | |
| Vicat B 120 | 136 | 136 | 135 | 124 | 125 | 119 |
| UL 94 V at 1.5 mm (7 d/70° C.) | V-0/12 s | V-0/14 s | V-0/13 s | V-0/18 s | V-0/29 s | V-0/36 s |
| Thickness/total afterburning time | | | | | | |
| UL 94 V at 1.0 mm (7 d/70° C.) | V-0/37 s | V-0/41 s | V-0/25 s | | | |
| Thickness/total afterburning time | | | | | | |
| IZOD notched impact [kJ/m²] | 63.9 | 63.8 | 61.1 | 60.5 | 55.6 | 60 |
| Joint line strength [kJ/m²] | 101.1 | 118.5 | 125.2 | 40.9 | 75.4 | 26.7 |
| ESC test (rape oil), 2.4% outer fibre | 160 | 138 | 116 | 324 | 351 | 295 |
| strain, time to fracture [min] | | | | | | |

1. Composition comprising
A) from 60 to 95 parts by weight of aromatic polycarbonate and/or aromatic polyester carbonate,
B) from 1.0 to 15.0 parts by weight of rubber-modified graft polymer with a graft base selected from the group consisting of silicone rubber, silicone-acrylate rubber and acrylate rubber,
C) from 1.0 to 20.0 parts by weight of at least one cyclic phosphazene according to formula (X) 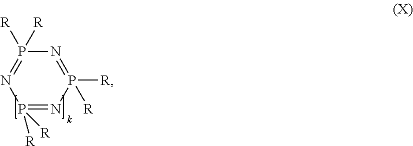
wherein
k represents 1 or an integer from 1 to 10, optionally a number from 1 to 8, optionally from 1 to 5,
wherein the trimer content (k=1) is from 60 to 98 mol %, based on component C,
and wherein
R
is in each case identical or different and represents an amine radical; C₁- to C₈-alkyl, optionally methyl, ethyl, propyl or butyl, each optionally halogenated, optionally halogenated with fluorine; C₁- to C₈-alkoxy, optionally methoxy, ethoxy, propoxy or butoxy; C₅- to C₆-cycloalkyl each optionally substituted by alkyl, optionally C ₁-C₄-alkyl, and/or by halogen, optionally chlorine and/or bromine; C₆- to C₂₀-aryloxy, optionally phenoxy, naphthyloxy, each optionally substituted by alkyl, optionally C₁-C₄-alkyl, and/or by halogen, optionally chlorine, bromine, and/or by hydroxy; C₇- to C₁₂-aralkyl, optionally phenyl-C₁-C₄-alkyl, each optionally substituted by alkyl, optionally C₁-C₄-alkyl, and/or by halogen, optionally chlorine and/or bromine; or a halogen radical, optionally chlorine; or an OH radical,
D) from 0 to 15.0 parts by weight of rubber-free vinyl (co)polymer or polyalkylene terephthalate,
E) from 0 to 15.0 parts by weight of one or more additives,
F) from 0.05 to 5.0 parts by weight, optionally from 0.1 to 2.0 parts by weight, optionally from 0.1 to 1.0 part by weight, of one or more antidripping agents,
wherein all the parts by weight are optionally normalised that the sum of the parts by weight of all the components A+B+C+D+E+F in the composition is 100.

2. Composition according to claim 1, wherein the content of trimers (k=1) is from 60 to 98 mol %, optionally from 65 to 95 mol %, optionally from 65 to 90 mol %, based on component C.

3. Composition according to claim 1, wherein the amount of component C is from 1.5 to 10.0 parts by weight.

4. Composition according to claim 1, wherein component C is selected from the group consisting of propoxyphosphazenes, phenoxyphosphazenes, methylphenoxyphosphazenes, aminophosphazenes and fluoroalkylphosphazenes.

5. Composition according to claim 1, wherein R is phenoxy.

6. Composition according to claim 1, wherein the content of trimers (k=1) is from 65 to 85 mol %, based on component C.

7. Composition according to claim 1, wherein the trimer content (k=1) is from 65 to 85 mol %, the tetramer content (k=2) is from 10 to 20 mol %, the content of higher oligomeric phosphazenes (k=3, 4, 5, 6 and 7) is from 5 to 15 mol %, and the content of phosphazene oligomers with k>=8 is from 0 to 1 mol %, in each case based on component C.

8. Composition according to claim 1, wherein component D) is present in an amount of from 3.0 to 6.0 parts by weight.

9. Composition according to claim 1, wherein the thermoplastic aromatic polycarbonates have a mean molecular weight (weight-average) of from 22,000 to 30,000 g/mol.

10. Composition according to claim 1, wherein component B comprises one or more graft polymers of
B.1 from 9 to 30 wt. % of one or more vinyl monomers on
B.2 from 91 to 70 wt. % of one or more silicone-acrylate composite rubbers as graft base,
wherein two mentioned rubber components of the graft base interpenetrate in the composite rubber so that said rubber components are substantially inseparable from one another.

11. Composition according to claim 1, wherein the graft base in component B comprises a silicone-acrylate rubber of from 9 to 40 wt. % silicone rubber and from 91 to 60 wt. % polyalkyl (meth)acrylate rubber, wherein two mentioned rubber components interpenetrate in the composite rubber so that said rubber components are substantially inseparable from one another.

12. Composition according to claim 1, comprising as component E at least one additive selected from the group consisting of flame-retardant synergists, antidripping agents, lubricants and demoulding agents, nucleating agents, stabilisers, antistatics, colourants, pigments, and fillers and reinforcing materials.

13. A cyclic phosphazene according to formula (X) 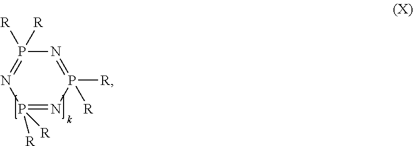
Capable of being used in production of a flame-retardant polymer composition having a property combination of excellent mechanical properties, very good flame resistance, high hydrolytic stability and high resistance to chemicals (ESC behaviour), wherein
k represents 1 or an integer from 1 to 10, optionally a number from 1 to 8, optionally from 1 to 5,
wherein the trimer content (k=1) is from 60 to 98 mol %, based on component C, and wherein
R
is in each case identical or different and represents an amine radical; C₁- to C₈-alkyl, optionally methyl, ethyl, propyl or butyl, each optionally halogenated, optionally halogenated with fluorine; C₁- to C₈-alkoxy, optionally methoxy, ethoxy, propoxy or butoxy; C₅- to C₆-cycloalkyl each optionally substituted by alkyl, optionally C ₁-C₄-alkyl, and/or by halogen, optionally chlorine and/or bromine; C₆- to C₂₀-aryloxy, optionally phenoxy, naphthyloxy, each optionally substituted by alkyl, optionally C₁-C₄-alkyl, and/or by halogen, optionally chlorine, bromine, and/or by hydroxy; C₇- to C₁₂-aralkyl, optionally phenyl-C₁-C₄-alkyl, each optionally substituted by alkyl, optionally C₁-C₄-alkyl, and/or by halogen, optionally chlorine and/or bromine; or a halogen radical, optionally chlorine; or an OH radical.

14. A composition according to claim 1 capable of being used in production of one or more injection-moulded and/or thermoformed moulded articles.

15. Moulded article obtainable from a composition according to claim 1.
